(19) United States
(12) Patent Application Publication
(10) Pub. No.: US 2006/0099985 A1
(43) Pub. Date: May 11, 2006

(54) Apparatus and method for radio transmission in a cellular communication system

(76) Inventors: Nick W. Whinnett, Marlborough (GB); Amitava Ghosh, Buffalo Grove, IL (US); Rapeepat Ratasuk, Schaumburg, IL (US); Weimin Xiao, Barrington, IL (US)

Correspondence Address: MOTOROLA, INC., 1303 EAST ALGONQUIN ROAD, IL01/3RD, SCHAUMBURG, IL, 60196, US

(21) Appl. No.: 10/984,162

(22) Filed: Nov. 9, 2004

(51) Int. Cl. H04Q 7/20

(52) U.S. Cl. 455/522

(57) ABSTRACT

A base station (101) of a cellular communication system (100) comprises a receiver (105) and a channel quality processor (111) which receive channel quality indications from a communication unit (103). The base station (101) further comprises a transmitter (107) for transmitting signals to the communication unit (103). A first power control processor (115) controls the transmit power in response to a first power control mode of operation and a second power control processor (117) controls the transmit power in response to the second power control mode of operation. A rate processor (113) determines a rate of change indication for the channel quality indications and a selector (119) selects between the first power control mode and the second power control mode in response to the rate of change indication. The power control mode of operation may be modified to suit the current channel variations of the communication channel. The invention may be applicable to an HSDPA service in a UMTS cellular communication system.

### FIELD OF THE INVENTION

The invention relates to an apparatus and a method for radio transmission in a cellular communication system and in particular, but not exclusively, to power control operations in a 3^{rd} Generation cellular communication system.

### BACKGROUND OF THE INVENTION

In a cellular communication system a geographical region is divided into a number of cells each of which is served by a base station. The base stations are interconnected by a fixed network which can communicate data between the base stations. A mobile station is served via a radio communication link by the base station of the cell within which the mobile station is situated.

As a mobile station moves, it may move from the coverage of one base station to the coverage of another, i.e. from one cell to another. As the mobile station moves towards a base station, it enters a region of overlapping coverage of two base stations and within this overlap region it changes to be supported by the new base station. As the mobile station moves further into the new cell, it continues to be supported by the new base station. This is known as a handover or handoff of a mobile station between cells.

A typical cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2^{nd} generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. A base station may be allocated a single carrier or a multiple of carriers. One carrier is used for a pilot signal which further contains broadcast information. This carrier is used by mobile stations for measuring of the signal level of transmissions from different base stations, and the obtained information is used for determining a suitable serving cell during initial access or handovers. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3^{rd} generation systems are being rolled out to further enhance the communication services provided to mobile users. The most widely adopted 3^{rd} generation communication systems are based on Code Division Multiple Access (CDMA) wherein user separation is obtained by allocating different spreading and scrambling codes to different users on the same carrier frequency. The transmissions are spread by multiplication with the allocated codes thereby causing the signal to be spread over a wide bandwidth. At the receiver, the codes are used to de-spread the received signal thereby regenerating the original signal. Each base station has a code dedicated for a pilot and broadcast signal, and as for GSM this is used for measurements of multiple cells in order to determine a serving cell. An example of a communication system using this principle is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

In a UMTS CDMA communication system, the communication network comprises a core network and a Radio Access Network (RAN). The core network is operable to route data from one part of the RAN to another, as well as interfacing with other communication systems. In addition, it performs many of the operation and management functions of a cellular communication system, such as billing. The RAN comprises the base stations, which in UMTS are known as Node Bs, as well as Radio Network Controllers (RNC) which control the Node Bs and the communication over the air interface.

Although 3^{rd} Generation systems are currently being rolled out, the standardisation process has continued to develop the systems to provide additional functionality and new services. For example, an efficient method of supporting downlink packet data known as the High Speed Downlink Packet Access (HSDPA) service has been defined. Currently, standardisation efforts include the definition of an High Speed Uplink Packet Access service (HSUPA) for efficiently supporting packet data communication in the uplink direction. HSDPA and HSUPA use a number of similar techniques including incremental redundancy and adaptive transmit format adaptation. In particular, HSDPA and HSUPA provide for modulation formats and code rates to be modified in response to dynamic variations in the radio environment. Furthermore, HSDPA and HSUPA use a retransmission scheme known as Hybrid Automatic Repeat reQuest (H-ARQ). In the H-ARQ scheme incremental redundancy is provided by soft combining data from the original transmission and any retransmissions of a data packet.

It is important to manage radio links between base stations and communication units such that the resource used by a given communication link is as low as possible. Thus, it is important to minimise the interference caused by the communication to or from a mobile station, and consequently it is important to use the lowest possible transmit power. As the required transmit power depends on the instantaneous propagation conditions, it is necessary to dynamically control transmit powers to closely match the conditions. For this purpose, the base stations and mobile stations operate power control loops, where the receiving end reports information on the receive quality back to the transmitting end, which in response adjusts its transmit power.

Specifically, in WCDMA, the downlink power control operates by the mobile station calculating the signal to interference ratio (SIR), comparing this to a desired downlink threshold, and transmitting a power down control signal to the base station if the SIR is above the threshold. If the SIR is not above the threshold, the mobile station transmits a power up control signal. In the uplink direction, the base stations measure the received SIR and compare it to an uplink SIR threshold. If the SIR is above the threshold, it transmits a power down control signal to the mobile station, and if below the threshold it transmits a power up control signal.

Although the conventional approach for power control is suitable in many situations, it has associated disadvantages and in particular provides sub-optimal performance in many scenarios.

For example, for HSDPA services, a channel known as the High Speed-Shared Control CHannel (HS-SCCH) carries downlink signalling information to the mobile stations. The downlink signalling information is required for demodulating the High Speed-Downlink Shared CHannel (HS-DSCH) which carries user data. In the Technical Specifications developed by the 3^{rd} Generation Partnership Project (3GPP) for HSDPA, power control of the HS-SCCH is not specifically defined except that it is controlled by the serving base station. As a result, the operator of the base station is allowed to implement any power control algorithm.

One option is to use a traditional power control method in accordance with Release 99 of the UMTS Technical Specifications. This approach provides for a simple power control of the HS-SCCH by coupling the transmit power of the HS-SCCH with the downlink of the Dedicated Physical Control CHannel (DPCCH) through the use of an offset factor. The DPCCH is a downlink channel which is always on (when there is packet data to be transmitted on the HS-DSCH) and which is therefore suitable for tracking the dynamic variations of the communication channel. Hence, in accordance with this approach, a suitable transmit power for the DPCCH is determined and the transmit power for transmissions on the HS-SCCH is then determined by applying an offset to the DPCCH transmit power.

However, although this is easy to implement, it may result in significantly degraded performance for the HS-SCCH. In particular, in contrast to the HS-SCCH, the DPCCH may operate in soft-handover. In such a case, the diversity combining gain will result in the DPCCH requiring much less power for some of the time, depending on the relative instantaneous powers of the multiple DPCCHs received at the mobile station. However, as the HS-SCCH still has identical power requirements as in the non-soft handover case, the HS-SCCH will be transmitted at too low power. Alternatively, the offset may be set sufficiently high to compensate for the possibility of the DPCCH being in soft handover. However, this will require the HS-SCCH to be transmitted at excessive power when the DPCCH is not in soft handover, thereby increasing resource usage and reducing the capacity of the system. Alternatively, the increased offset may be applied only when the DPCCH operates in soft handover. However, this will still result in excessive HS-SCCH power for some of the time depending on the relative instantaneous powers of the multiple DPCCHs received at the mobile station.

Another option is to set the HS-SCCH transmit power in response to the Channel Quality Indicators (CQI) reports which are transmitted periodically from the mobile station to the base station in an HSDPA service (the CQIs are transmitted on the High Speed-Dedicated Physical Control CHannel (HS-DPCCH)). The CQI reports comprise information on the current received quality of the downlink signals from the serving base station.

An advantage of CQI-based power control is that it decouples HS-SCCH power control from that of the DPCCH. This allows efficient power control of the HS-SCCH in soft handover scenarios without compromising the performance of the dedicated channels since the CQI reports relate only to downlink signals from the serving base station. However, the performance that can be achieved is highly dependent on the fading characteristics of the radio channel, the CQI reporting period and the feedback delay in HSDPA, the maximum CQI reporting frequency is 500 Hz, which renders CQI-based power control ineffective at medium vehicular speeds (around 30 km/h) and above.

Furthermore, both methods suffer from a delay between channel measurements and actual power adjustments causing a mismatch between the actual channel condition and the application of the power control.

Hence, an improved system for radio transmission would be advantageous and in particular a system allowing improved power control performance, facilitated power control, increasing reliability of the transmissions and/or improved resource usage would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for radio transmission in a cellular communication system; the apparatus comprising: a receiver for receiving channel quality indications from a communication unit; means for determining a rate of change indication for the channel quality indications; means for controlling a transmit power of a signal in response to a first power control mode of operation; means for controlling a transmit power of the signal in response to a second power control mode of operation; and means for selecting between the first power control mode and the second power control mode in response to the rate of change indication.

The invention may provide improved performance in a cellular communication system. In particular, the invention may provide improved power control performance thereby providing a more efficient resource utilisation. The capacity of the cellular communication system may be increased. In some embodiments, an improved reliability of the transmissions may be provided.

In particular, the invention may in some embodiments provide a low complexity power control operation which is dynamically adapted to suit the current conditions. For example, the rate of change indication may be dependent on a velocity of the communication unit thereby allowing the power control operation to be adapted to the current movement characteristics of the communication unit.

According to an optional feature, the means for selecting is operable to compare the rate of change indication to a threshold and to select the first power control mode if the rate of change is below the threshold and the second power control mode if the rate of change is not below the threshold. This may provide for a low complexity method of adapting the power control operation.

According to an optional feature, the apparatus further comprises means for determining the threshold in response to a time interval between the channel quality indications. The time interval may for example correspond to a feedback period or a reporting frequency of the channel quality indications. The feature may allow a simplified and/or accurate determination of a suitable threshold for switching between different power control modes.

According to an optional feature, the second mode of power control comprises not adjusting a transmit power in response to information from the communication unit. This may provide for a high performance and facilitated operation. For example, the second mode of power control may be utilised when the channel quality indicators are indicative of a fast changing communication channel. In such cases, active power control may actually degrade the performance and an improvement may be achieved by not adjusting the transmit power. Furthermore, this improvement may be achieved without sacrificing power control performance for slower changing channels, such as when the communication unit is moving at slower speeds.

According to an optional feature, the second mode of power control comprises transmitting at a static power level. For example, transmissions may be made using a fixed predetermined transmit power. This may facilitate operation while providing suitable performance.

According to an optional feature, the apparatus comprises means for, in the first mode of power control, determining a transmit power in response to the channel quality indications.

This may provide for high performance and/or facilitated operation. For example, the first mode of power control may be utilised when the channel quality indicators are indicative of a slowly changing communication channel. In such cases, active power control may improve performance and in particular the use of the channel quality indicators may improve performance and allow a dual use of the channel quality indicators. Furthermore, this improvement may be achieved without sacrificing power control performance for faster changing channels, such as when the communication unit is moving at higher speeds. Thus, the invention may allow an optimised power control mode of operation to be dynamically adapted to the current conditions which may be estimated by the channel quality indicators. Thus a low complexity dynamically adapting power control operation with improved performance may be achieved in many embodiments.

According to an optional feature, the channel quality indications comprise an indication of a signal to noise ratio of the signal at the communication unit. This provides a suitable measure for controlling power control modes and may furthermore be suited for control of the transmission power in one or both power control modes.

According to an optional feature, the signal to noise ratio is related to a pilot signal transmitted from the apparatus. This provides a suitable way of determining a signal to noise ratio indication appropriate for selecting between power control modes.

According to an optional feature, the channel quality indications are indicative of a channel quality associated with only a serving cell for the communication unit. For example, the channel quality indications may be determined in response to a signal transmitted only from the serving base station. The feature may provide particularly advantageous performance in many embodiments. For example, in embodiments wherein the signal cannot be transmitted in soft handover, such as for a HSDPA signal, an improved power control may be achieved by using channel quality indications which relate only to the serving cell.

According to an optional feature, the channel quality indications comprise an allowable transmission format parameter.

According to an optional feature, the channel quality indications are Channel Quality Indications (CQIs) in accordance with the Technical Specifications of the 3^{rd} Generation Partnership Project (3GPP). The invention may provide advantageous performance in a 3^{rd} Generation cellular communication system by using already defined CQIs for selecting between different power control modes.

According to an optional feature, the signal is a High Speed Shared Control CHannel (HS-SCCH) signal. The HS-SCCH signal may be any transmission on the HS-SCCH as specified in the Technical Specifications of the 3^{rd} Generation Partnership Project (3GPP).

According to an optional feature, the cellular communication system is a UMTS cellular communication system.

The apparatus may be a base station such as a Node B.

According to a second aspect of the invention, there is provided a method of radio transmission in a cellular communication system; the method comprising: receiving channel quality indications from a communication unit; determining a rate of change indication for the channel quality indications; controlling a transmit power of a signal in response to a first power control mode of operation or a second power control mode of operation; and selecting between the first power control mode and the second power control mode in response to the rate of change indication.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a cellular communication system incorporating an embodiment of the invention.

### DETAILED DESCRIPTION OF EMBODIMENTS OF THE INVENTION

The following description focuses on embodiments of the invention applicable to downlink transmissions in a 3^{rd} generation cellular communication system but it will be appreciated that the invention is not limited to this application.

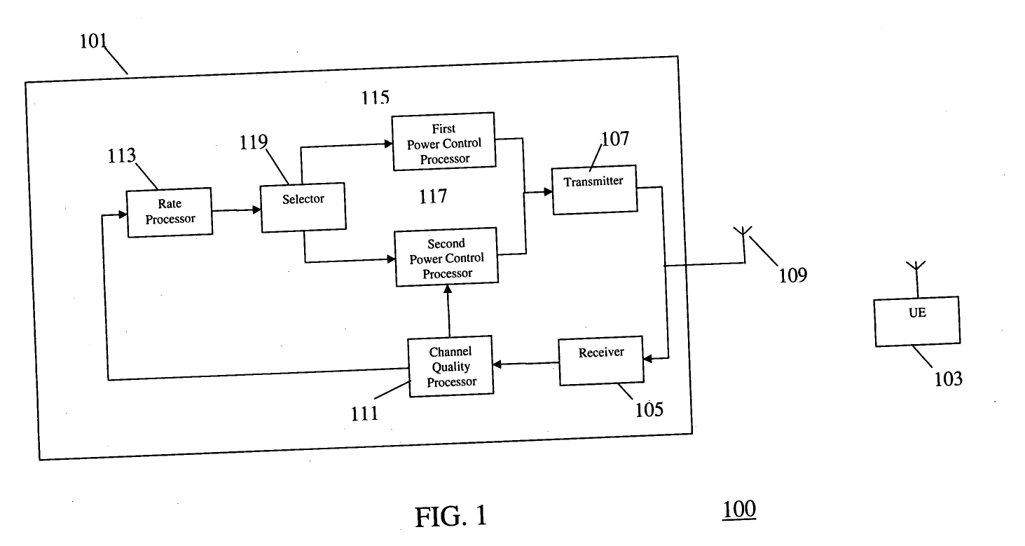

FIG. 1 illustrates a cellular communication system 100 incorporating an embodiment of the invention.

The cellular communication system comprises a base station 101 which supports a plurality of communication units of which only one 103 is shown. The communication unit 103 may typically be a User Equipment (UE), a subscriber unit, a mobile station, a communication terminal, a personal digital assistant, a laptop computer, an embedded communication processor or any physical, functional or logical communication element which is capable of communicating over the air interface of the cellular communication system.

The base station 101 comprises a receiver 105 and a transmitter 107 coupled to an antenna 109 (for example through a duplexer (not shown)). The receiver 105 comprises the required functionality for receiving signals from the communication unit 103 as will be well known to the person skilled in the art. Likewise, the transmitter 107 comprises the required functionality for transmitting signals to the communication unit 107 as will be well known to the person skilled in the art.

The receiver 105 is coupled to a channel quality processor 111 which extracts channel quality indications from the signals received by the receiver 105 from the communication unit 103. The channel quality indications are typically indications of the quality of the signal received by the communication unit 103 from the base station 101. Thus, the channel quality indications may for example be a signal to noise measure for a signal transmitted by the base station 101 and received by the communication unit 103. The channel quality indications are thus typically indicative of the receive quality of a signal transmitted from the base station 101 and may for example comprise a bit error rate indication, an interference indication, a receive level indication, a signal-to-noise ratio estimate indication, or a supportable transport format.

The channel quality indications are determined at the communication unit 103 and transmitted to the base station 101. The communication unit 103 may determine the channel quality indications in response to any suitable signal transmitted from the base station. In many embodiments, the base station 101 may transmit a pilot signal and the channel quality indications may be determined in response to a received signal level of the pilot signal and a measured interference level at the communication unit 103.

The channel quality processor 111 is coupled to a rate processor 113 which is operable to determine a rate of change indication for the channel quality indications.

The rate of change indication provides an indication of how fast the communication channel between the base station 101 and the communication unit 103 is changing. For example, for a fast changing channel, the channel quality indications typically exhibit a high rate of change indication, and for a slowly changing channel the channel quality indications typically exhibit a low rate of change indication. The channel conditions may for example change due to fades and/or interference variations and typically the speed at which the channel characteristics change depends on the speed of the communication unit 103. Thus, for a static communication unit 103, the communication channel is typically relatively constant and the channel quality indications will typically be slowly varying. In contrast, for a fast moving communication unit, the communication channel typically varies rapidly and the channel quality indications may accordingly vary rapidly.

The base station 101 of FIG. 1 comprises a first power control processor 115 and a second power control processor 117 both of which are coupled to the transmitter 107. The first power control processor 115 is operable to control the transmit power of the transmitter 107 in response to a first power control mode of operation and the second power control processor 117 is operable to control the transmit power of the transmitter 107 in response to a second power control mode of operation. Hence, in accordance with the example of FIG. 1, the base station 101 is operable to operate in (at least) two different power control modes. In particular, the first power control mode is designed to provide efficient power control for slowly varying channels whereas the second power control mode is designed to provide efficient power control for rapidly changing communication channels.

The first power control processor 115 and the second power control processor 117 are coupled to a selector 119 which is further coupled to the rate processor 113. The selector 119 is operable to receive the rate of change indication from the rate processor 113 and to select between the first power control mode and the second power control mode in response to the rate of change indication.

Specifically, the selector 119 may select the first power control processor 115 to be active when the rate of change indication is indicative of a slowly varying channel and the second power control processor 117 when the rate of change indication is indicative of a rapidly varying channel.

The efficient power control of transmissions in a cellular communication system may depend significantly on the characteristics of the communication channel and by selecting between two different power control modes in accordance with a rate of change of channel quality indications, a significantly improved power control operation which is optimised for the current conditions may be achieved.

For example, in many communication systems, the power control feedback dynamics prevent power control to be effective for rapidly varying communication channels whereas it provides highly efficient power control for slowly varying communication channels. In fact, in some systems, the specified power control algorithms actually degrade the performance of the transmissions for rapidly varying communication channels. Hence, for these channels active power control may result in a higher error rate and/or increased resource usage.

In accordance with some of the embodiments of FIG. 1, this problem is obviated or eliminated by the use of a plurality of control algorithms and a selection between these being made in response to a rate of change indication of channel quality indications. Specifically, a conventional power control algorithm may for example be operated by the first power control processor 115 when in the first power control mode whereas the second power control processor 117 may implement a simple power control mode which consists in setting the transmit power independently of information received from the communication unit 103. Specifically, the second power control processor 117 may simply set a fixed predetermined transmit power for the transmitter 107 when the base station 101 is operating in the second power control mode. Accordingly, efficient power control is obtained for slowly varying communication channels without sacrificing performance for faster varying communication channels.

FIG. 1 illustrates functional blocks of the apparatus for some embodiments of the invention. The individual functional blocks may for example be implemented in a suitable processor such as a microprocessor, a microcontroller or a digital signal processor. The functions of the illustrated blocks may for example be implemented as firmware or software routines running on suitable processor(s) or processing platform(s). However, some or all of the functional blocks may be implemented fully or partially in hardware. For example, the functional blocks may be fully or partially implemented as analog or digital circuitry or logic.

The functional blocks may furthermore be implemented separately or may be combined in any suitable way. For example, the same processor or processing platform may perform the functionality of more than one of the functional blocks. In particular, a firmware or software program of one processor may implement the functionality of two or more of the illustrated functional blocks. For example, the channel quality processor 111, the rate processor 113, the selector 119, the first power control processor 115 and/or the second power control processor 117 may be implemented as different firmware routines running in a single processor. The functionality of different functional modules may for example be implemented as different sections of a single firmware or software program, as different routines (e.g. subroutines) of a firmware or software program or as different firmware or software programs.

The functionality of the different functional modules may be performed sequentially or may be performed fully or partially in parallel. Parallel operation may include a partial or full time overlap between the performed functions.

The functional elements may be implemented in the same physical or logical element and may for example be implemented in the same network element such as in a base station as illustrated. The functionality of individual functional units may also be distributed between different logical or physical elements.

In the following, some embodiments of the invention particularly suitable for an HSDPA service of a UMTS cellular communication system will be described in more detail. The embodiments are compatible with the system of FIG. 1 and will be described with reference to this.

In the embodiments, the communication unit 103 transmits Channel Quality Indications (CQIs) in accordance with the Technical Specifications for the UMTS cellular communication system as specified by the 3^{rd} Generation Partnership Project (3GPP).

In the embodiments, signals supporting an HSDPA service are transmitted to the communication unit 103 on the High Speed Shared Control CHannel (HS-SCCH). In accordance with some embodiments of the invention, a power control operation for an HS-SCCH channel is provided wherein different power control modes are selected in response to characteristics of the CQIs received from the communication unit 103.

The received CQIs are indicative of the received signal to noise ratio at the communication unit 103 of signals transmitted from the base station 101. In particular, the CQIs are determined in response to the pilot signal transmitted by the base station 101 and accordingly relate only to signals transmitted from the serving base station 101. The CQIs comprise an indication of which transmit formats that may be used by the base station 101 when transmitting to the communication unit 103. The better the signal to noise ratio, the more transmit formats may be used and in particular the more data may be transmitted in a given resource allocation. Thus, the allowable transmit format indication of the CQIs are directly related to a signal to noise ratio.

In accordance with some of the specific embodiments, the channel quality processor 111 receives CQIs from the communication unit 103 on the High Speed-Dedicated Physical Control CHannel (HS-DPCCH). As mentioned above, the communication unit 103 does not report the received signal level or the signal to noise ratio directly. Instead, the communication unit 103 transmits CQIs indicative of a maximum transport block size, the number of HS-PDSCH codes and the modulation level that the communication unit 103 is able to receive for the current conditions.

The rate processor 113 may receive the normalized CQI values and determine a rate of change indication. For example, the rate of change indication M(k) for the k'th CQI report given by the following formula may be calculated:
M(k)=αM(k−1)+(1−α)|CQI(k)−CQI(k−1)|
where α is a design parameter which may be selected to provide a suitable weighting between current and previous values.

The selector 119 receives the rate of change indication M(k) and selects between the first and second power control mode in response to the rate of change indication. Specifically, the selector 119 may compare the current rate of change indication to a threshold and select the first power control mode if the rate of change is below the threshold and the second power control mode if the rate of change is not below the threshold. The threshold may be determined in response to the time intervals between the received CQIs.

Specifically, the rate of change indication may be compared to a predefined threshold that is based on the CQI reporting interval (e.g. 2, 10, 20 ms), i.e. if
M(k)≦T(T_{fbc})
where T_{fbc} is the CQI reporting interval, the first power control mode will be selected and otherwise the second power control mode will be selected. The threshold is in the example set according to the reporting interval T_{fbc} and may be determined e.g. via the execution of a mathematical function or via a look-up table.

In some of the embodiments for HSDPA, the second power control mode specifically corresponds to not implementing a dynamic power control. Rather, for rate of change indications above the threshold, the second power control processor 117 may simply set the transmit power of the HS-SCCH transmissions to a fixed predetermined level. Simulations and measurements show that improved performance may be obtained by transmitting at a fixed transmit power level if the update rate of the CQIs is not sufficiently fast to follow the dynamic variations of the communication channel.

Furthermore, the first power control processor 115 may set the transmit power of HS-SCCH transmissions in response to the CQIs. This may provide sufficient power control performance when the update rate of the CQI is sufficient to track the dynamic variations of the communication channel.

In particular, if the rate of change indication is below the threshold, the transmit power of the downlink HS-SCCH may at each update interval k be set as follows. Calculate the linear average of the last n (e.g. n=3) received CQI values:

$$CQI\_avg ( k ) = \frac{{10}^{CQI ( k ) / 10} + {10}^{CQI ( k - 1 ) / 10} + {10}^{CQI ( k - 2 ) / 10}}{4}$$

Calculate a reference received Ec/Nt of HS-SCCH, assuming HS-SCCH is transmitted with a power equal to total cell power:
Ec_{—}Nt_ref=CQI_avg(k).10^{-(16.5+Γ+CPICH}^{_{—}}^{power)/10}

CPICH_power is the pilot power in dB relative to total cell power. Γ is the measurement power offset defined in 3GPP TS 25.214 v.5.9.0.

Calculate the required power for HS-SCCH (P_{HS-SCCH}^{TX}) to meet desired Ec/Nt target at the receiver (HS-SCCH_Ec_Nt_Target, linear units), under a maximum power constraint of P_{HS}_{_{—}}_{SCCH}_{_{—}}ₘₐₓ:

$${P}_{HS - SCCH}^{TX} = min ( {P}_{HS\_SCCH \_max} , \frac{HS\_SCCH \_Ec \_Nt \_Target}{Ec\_Nt \_ref} )$$

The power units in the above equation are linear fraction of total cell power.

It will be appreciated that a number of advantages may be achieved by the described system including:
The system is based on CQI information relating only to the serving cell and the determined transmit power is accordingly independent on whether the communication unit 103 is in a soft handover mode or not. As HSDPA channels such as the HS-SCCH cannot operate in soft handover, an improved transmit power setting suitable for the specific channels is achieved. Hence, no operational changes are required when the system is in soft handover (there is thus no Release 99 soft handover problem). As the base station in a cellular communication system, such as UMTS, may not know whether a communication unit 103 is in soft handover, this may provide a substantial advantage.
Active dynamic power control is only performed when it is most beneficial (such as at low speeds) and is not performed when it may degrade the performance (such as at high speeds).
A simple metric is used to decide whether to perform active dynamic power control for HS-SCCH transmissions.
One-step power adjustment may be achieved instead multiple power adjustments when using a fixed step size.
A filtering of the CQI values may be performed to smooth out CQI fluctuations thereby improving performance and preventing erroneous CQI reports from significantly degrading HS-SCCH performance.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for radio transmission in a cellular communication system; the apparatus comprising:
a receiver for receiving channel quality indications from a communication unit;
means for determining a rate of change indication for the channel quality indications;
means for controlling a transmit power of a signal in response to a first power control mode of operation;
means for controlling a transmit power of the signal in response to a second power control mode of operation; and
means for selecting between the first power control mode and the second power control mode in response to the rate of change indication.

2. The apparatus of claim 1 wherein the means for selecting is operable to compare the rate of change indication to a threshold and to select the first power control mode if the rate of change is below the threshold, and the second power control mode if the rate of change is not below the threshold.

3. The apparatus claimed in claim 2 further comprising means for determining the threshold in response to a time interval between the channel quality indications.

4. The apparatus claimed in claim 1 wherein the second mode of power control comprises not adjusting a transmit power in response to information from the communication unit.

5. The apparatus claimed in claim 4 wherein the second mode of power control comprises transmitting at a static power level.

6. The apparatus claimed in claim 1 wherein the apparatus comprises means for, in the first mode of power control, determining a transmit power in response to the channel quality indications.

7. The apparatus as claimed in claim 1 wherein the channel quality indications comprise an indication of a signal to noise ratio of the signal at the communication unit.

8. The apparatus as claimed in claim 7 wherein the signal to noise ratio is related to a pilot signal transmitted from the apparatus.

9. The apparatus claimed in claim 1 wherein the channel quality indications are indicative of a channel quality associated with only a serving cell for the communication unit.

10. The apparatus claimed in claim 1 wherein the channel quality indications comprise an allowable transmission format parameter.

11. The apparatus claimed in claim 1 wherein the channel quality indications are Channel Quality Indications (CQIs) in accordance with the Technical Specifications of the 3^{rd} Generation Partnership Project (3GPP).

12. The apparatus claimed in claim 1 wherein the signal is a High Speed Shared Control CHannel (HS-SCCH) signal

13. The apparatus claimed in claim 1 wherein the cellular communication system is a UMTS cellular communication system.

14. A base station comprising an apparatus as claimed in claim 1.

15. A method of radio transmission in a cellular communication system; the method comprising:
receiving channel quality indications from a communication unit;
determining a rate of change indication for the channel quality indications;
controlling a transmit power of a signal in response to a first power control mode of operation or a second power control mode of operation; and
selecting between the first power control mode and the second power control mode in response to the rate of change indication.
